(19) United States
(12) Patent Application Publication
(10) Pub. No.: US 2011/0006952 A1
(43) Pub. Date: Jan. 13, 2011

(54) MOBILE WIRELESS COMMUNICATIONS DEVICE INCLUDING WRAP-AROUND ANTENNA ASSEMBLY WITH FEED ARM EXTENSION AND RELATED METHODS

(75) Inventors: Mina Ayatollahi, Waterloo (CA); Ying Tong Man, Waterloo (CA); Yihong Qi, Waterloo (CA); Perry Jarmuszewski, Waterloo (CA)

Correspondence Address: Allen, Dyer, Doppelt, Milbrath & Gilchrist - RIM, 255 S. Orange Avenue, Suite 1401, Orlando, FL, 32801, US

(73) Assignee: Research in Motion Limited, Waterloo (CA)

(21) Appl. No.: 12/499,169

(22) Filed: Jul. 8, 2009

(51) Int. Cl. H01Q 1/38; H01Q 1/24; H01P 11/00

(52) U.S. Cl. 343/702; 29/600; 343/700 MS

(57) ABSTRACT

A mobile wireless communications device may include a portable housing, at least one wireless communications circuit carried by the portable housing, and a wrap-around antenna assembly carried by the portable housing. The wrap-around antenna assembly may include a substrate comprising a first portion and a second portion extending outwardly therefrom defining an L-shape, and a wrap-around antenna element lying along adjacent contiguous exterior surfaces of the first and second substrate portions. The wrap-around antenna assembly may further include an antenna feed arm lying along an interior surface of the first substrate portion and electrically coupled to the wrap-around antenna element, and a feed arm extension electrically coupled to the antenna feed arm and extending from the interior surface of the first substrate portion around to the exterior surface thereof.

### TECHNICAL FIELD

The present disclosure relates to the field of communications systems, and, more particularly, to mobile wireless communications devices and related methods.

### BACKGROUND

Mobile wireless communications systems continue to grow in popularity and have become an integral part of both personal and business communications. For example, cellular telephones allow users to place and receive voice calls most anywhere they travel. Moreover, as cellular telephone technology has increased, so too has the functionality of cellular devices and the different types of devices available to users. For example, many cellular devices now incorporate personal digital assistant (PDA) features such as calendars, address books, task lists, etc. Moreover, such multi-function devices may also allow users to wirelessly send and receive electronic mail (email) messages and access the Internet via a cellular network and/or a wireless local area network (WLAN), for example.

Even so, as the functionality of cellular communications devices continues to increase, so too does the demand for smaller devices which are easier and more convenient for, users to carry. One challenge this poses for cellular device manufacturers is designing antennas that provide desired operating characteristics within the relatively limited amount of space available for antennas.

### BRIEF DESCRIPTION OF THE DRAWINGS

FIG. 1 is a schematic side view of a mobile wireless communications device in accordance with one exemplary embodiment.

FIG. 2 is an exterior surface view of a first substrate portion of an exemplary wrap-around antenna assembly for use with the mobile wireless communications device of FIG. 1.

FIG. 3 is an interior surface view of a second substrate portion of the wrap-around antenna assembly of FIG. 2.

FIG. 4 is an interior surface view of the first substrate portion of the wrap-around antenna assembly of FIG. 2.

FIG. 5 is an exterior surface view of the second substrate portion of the wrap-around antenna assembly of FIG. 2.

FIG. 6 is an exterior surface view of a first substrate portion of an alternative embodiment of the wrap-around antenna assembly shown in FIG. 2.

FIG. 7 is a flow diagram illustrating a method for making a wrap-around antenna assembly in accordance with an exemplary embodiment.

FIG. 8 is a schematic block diagram illustrating exemplary components of a mobile wireless communications device that may be used in accordance with exemplary embodiments.

### DETAILED DESCRIPTION

The present description is made with reference to the accompanying drawings, in which exemplary embodiments are shown. However, many different exemplary embodiments may be used, and thus the description should not be construed as limited to the exemplary embodiments set forth herein. Rather, these exemplary embodiments are provided so that this disclosure will be thorough and complete. Like numbers refer to like elements throughout, and prime notation is used to indicate similar elements or steps in different embodiments.

Generally speaking, a mobile wireless communications device is provided herein which may include a portable housing, at least one wireless communications circuit carried by the portable housing, and a wrap-around antenna assembly carried by the portable housing. The wrap-around antenna assembly may include a substrate comprising a first portion and a second portion extending outwardly therefrom defining an L-shape, and a wrap-around antenna element lying along adjacent contiguous exterior surfaces of the first and second substrate portions. The wrap-around antenna assembly may further include an antenna feed arm lying along an interior surface of the first substrate portion and electrically coupled to the wrap-around antenna element, and a feed arm extension electrically coupled to the antenna feed arm and extending from the interior surface of the first substrate portion around to the exterior surface thereof.

In some embodiments, the feed arm extension may have a distal end defining a gap from adjacent portions of the wrap-around antenna element. By way of example, the gap may be not greater than 2 mm. In other embodiments, the feed arm extension may have a distal end electrically coupled to adjacent portions of the wrap-around antenna element.

The wrap-around antenna element and the feed arm extension may advantageously provide pentaband operation, for example. Additionally, the wrap-around antenna assembly may further include a floating, electrically conductive coupler element adjacent the feed arm extension. More particularly, the floating, electrically conductive coupler element may be spaced apart from and generally parallel to the feed arm extension.

Furthermore, the wrap-around antenna assembly may also include a monopole antenna element carried by the first portion of the substrate. In addition, the mobile wireless communications device may also include a printed circuit board (PCB) carried by the portable housing and carrying the at least one wireless RF circuit, and the substrate may be carried by the PCB. By way of example, the wrap-around antenna element may comprise an inverted-F antenna element, and the at least one wireless RF circuit may comprise at least one cellular transceiver.

A wrap-around antenna assembly for mobile wireless communications device, such as the one described briefly above, may include a substrate comprising a first portion and a second portion extending outwardly therefrom defining an L-shape, and a wrap-around antenna element lying along adjacent contiguous exterior surfaces of the first and second substrate portions. The assembly may further include an antenna feed arm lying along an interior surface of the first substrate portion and electrically coupled to the wrap-around antenna element, and a feed arm extension electrically coupled to the antenna feed arm and extending from the interior surface of the first substrate portion around to the exterior surface thereof.

A related method for making a wrap-around antenna assembly may include forming a substrate comprising a first portion and a second portion extending outwardly therefrom defining an L-shape, and positioning a wrap-around antenna element along adjacent contiguous exterior surfaces of the first and second substrate portions. The method may further include positioning an antenna feed arm along an interior surface of the first substrate portion and electrically coupled to the wrap-around antenna element, and electrically coupling a feed arm extension to the antenna feed arm and extending from the interior surface of the first substrate portion around to the exterior surface thereof.

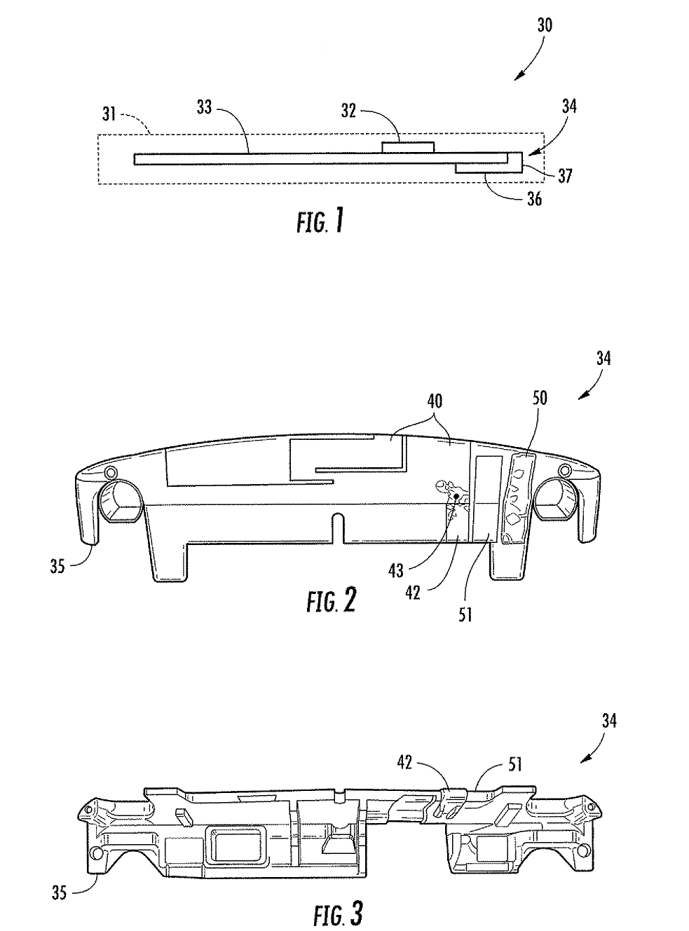

Referring now to FIGS. 1-5, a mobile wireless communications device is provided herein which illustratively includes a portable housing 31. By way of example, such mobile wireless communications devices (or “mobile devices”) may include pagers, cellular phones, cellular smart-phones, wireless organizers, personal digital assistants, computers, laptops, handheld wireless communication devices, wirelessly enabled notebook computers, etc.

In the illustrated example, the at least one wireless communications circuit 32 is carried by the portable housing 31. More particularly, the wireless communications circuit(s) 32 is mounted on a printed circuit board (PCB) 33, and the circuit may be a wireless transceiver, such as a cellular transceiver, for example. However, other wireless communications formats may also be used, such as wireless local area network (WLAN) formats, Bluetooth, etc., as will be discussed further below.

The device 30 further illustratively includes a wrap-around antenna assembly 34 carried by the portable housing 31. The wrap-around antenna assembly 34 illustratively includes a substrate 35 comprising a first portion 36 and a second portion 37 extending outwardly therefrom defining an L-shape, as seen in FIG. 1. More particularly, in the exemplary implementation, the longer portion of the L is the first portion 36, and the second portion 37 is the shorter portion which is orthogonal to the first portion.

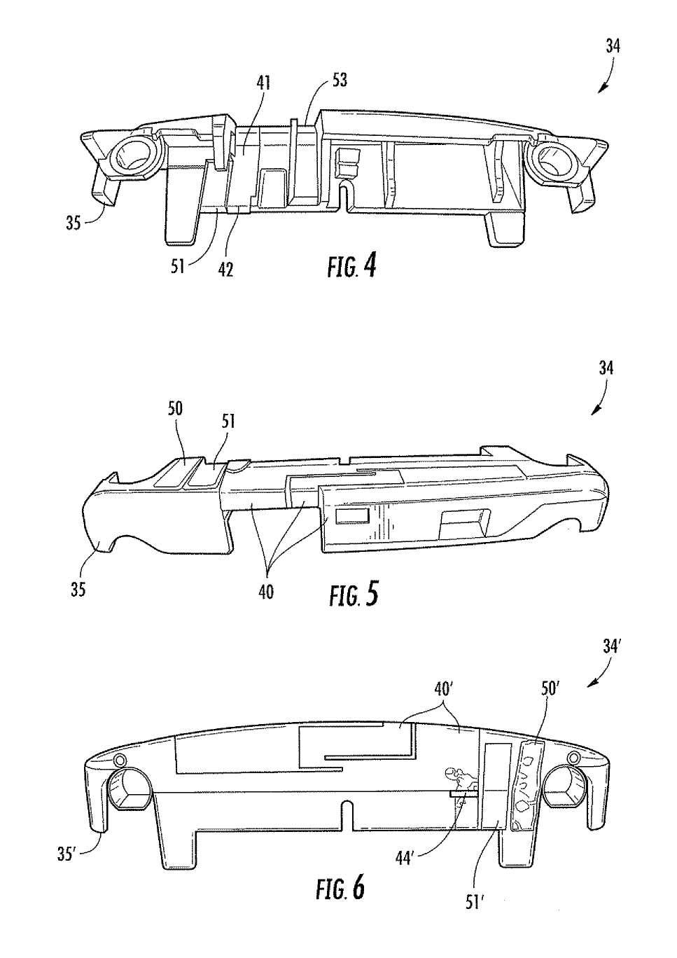

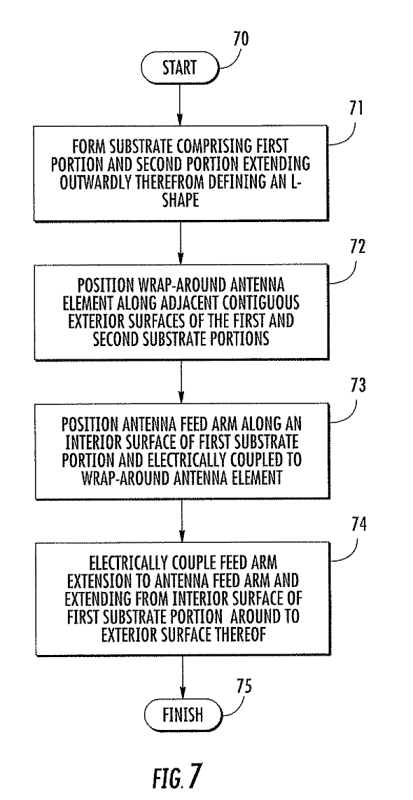

The wrap-around antenna assembly 34 further illustratively includes a wrap-around antenna element 40 lying along adjacent contiguous exterior surfaces of the first and second substrate portions 36, 37, as perhaps best seen in FIGS. 2 and 5. In the illustrated example, the wrap-around antenna element 40 is an inverted-F antenna comprising a plurality of conductive traces which are printed on the exterior surfaces of the first and second portions 36, 37, as will be appreciated by those skilled in the art. The wrap-around antenna assembly 34 further illustratively includes an antenna feed arm 41 lying along an interior surface of the first substrate portion 36 (FIG. 4) and electrically coupled to the wrap-around antenna element 40, and a ground arm 53 also lying along the interior surface of the first substrate portion. By way of example, the antenna feed arm 41 and ground arm 53 may respectively be connected to the circuit 32 and a ground plane (not shown) on the PCB 33 by conductive spring clips, flex connector, etc., as will be appreciated by those skilled in the art.

As a result of the L-shaped substrate 35, the wrap-around antenna assembly 34 advantageously provides a relatively compact form factor that can be secured to an end or side of the PCB 33, which advantageously frees up surface area of the PCB for other components, in that the conductive traces 40 need not be printed on a surface of the PCB itself. Further, due to the three-dimensional (3D) or non-planar nature of the wrap-around antenna element 40, which wraps around multiple surfaces of the substrate 35, this allows the antenna element to have a longer electrical length within the relatively small surface area occupied by the substrate 37.

The wrap-around antenna assembly 34 also illustratively includes a feed arm extension 42 electrically coupled to the antenna feed arm 41 on the inner surface of the first substrate portion 42 (see FIG. 4), and extending around to the exterior surface of the first substrate portion (see FIG. 2). In the illustrated embodiment, the feed arm extension has a distal end electrically coupled to adjacent portions of the wrap-around antenna element 40 at a point 43, as shown in FIG. 2.

In an alternative embodiment illustrated in FIG. 6, the distal end of the feed arm extension 42′ defines a gap 44′ from adjacent portions of the wrap-around antenna element 40′. By way of example, an exemplary width of the gap 44′ may be 2 mm or less, such as 0.5 to 2 mm, although other gap distances may be used in various embodiments.

The wrap-around antenna element 40 or 40′, with the addition of the feed arm extension 42 or 42′, advantageously provides pentaband operation across the CDMA, WCDMA, and GSM high/low frequency bands in the illustrated examples, as will be appreciated by those skilled in the art. However, without the addition of the feed arm extension 42 or 42′, the wrap-around antenna elements 40 or 40′ alone would otherwise provide quad-band operation.

In addition to providing operation across a greater frequency range, the feed arm extensions 42, 42′ advantageously provide enhanced gain and matching for the antenna element 40, 40′. The choice of whether to use the antenna assembly 34 (FIG. 2) or 34′ (FIG. 6), i.e., whether to have the gap 44′ or directly couple the feed arm extension 42 to the antenna 40, will generally depend upon the desired operating characteristics, and whether a greater enhancement in antenna gain or matching is desired. That is, the antenna assembly 34 generally provides greater gain enhancement, while the antenna assembly 34′ generally provides greater matching and tuning characteristics.

It should also be noted that in some embodiments the gap 44′ need not be directly adjacent to the antenna element 40′ (i.e., adjacent the point 43 in FIG. 2). That is, the gap 44′ may be located elsewhere along the length of the feed arm extension 42, if desired. Generally speaking, the length of the feed arm extension 42, 42′ on the interior surface of the substrate 35 and its distance to the antenna element 40, 40′ on the outer surface of the substrate controls the antenna matching (i.e., S11 bandwidth), and this is why the location and size of the gap 44′ is advantageously beneficial for matching and tuning adjustment.

In the illustrated example, the wrap-around antenna assembly 34 further illustratively includes a floating, electrically conductive coupler element 50 adjacent the feed arm extension 42. More particularly, the floating, electrically conductive parasitic coupler element 50 is spaced apart from and generally parallel to the feed arm extension 42 in the illustrated example, although other orientations or configurations may be used in different embodiments, as will be appreciated by those skilled in the art. By “spaced apart” it is meant that the coupler element 50 is not in contact with the feed arm extension 42 (or the antenna element 40), and the spacing may vary in different embodiments. The coupler element 50 advantageously may be used to further enhance antenna gain and matching across all of the operating bands. In addition, the length of the coupler element 50 and its spacing from the antenna element 40 and feed arm extension may advantageously be selected to further control frequency band operation, as will also be appreciated by those skilled in the art.

Furthermore, the wrap-around antenna assembly 34 also illustratively includes a monopole antenna element 51 carried by the first portion of the substrate 35 (FIG. 2), and also connected to the circuit 32 (or different wireless communications circuitry). The monopole antenna element 51 may optionally provide operation in one of the above-noted frequency bands, or in a separate frequency band, if desired, but it is not necessary in all embodiments. In embodiments where the monopole antenna element 51 is not present, the coupler element 50 may be located in its place (or elsewhere) to provide closer coupling to the feed arm extension 42 or antenna element 40, as will be appreciated by those skilled in the art.

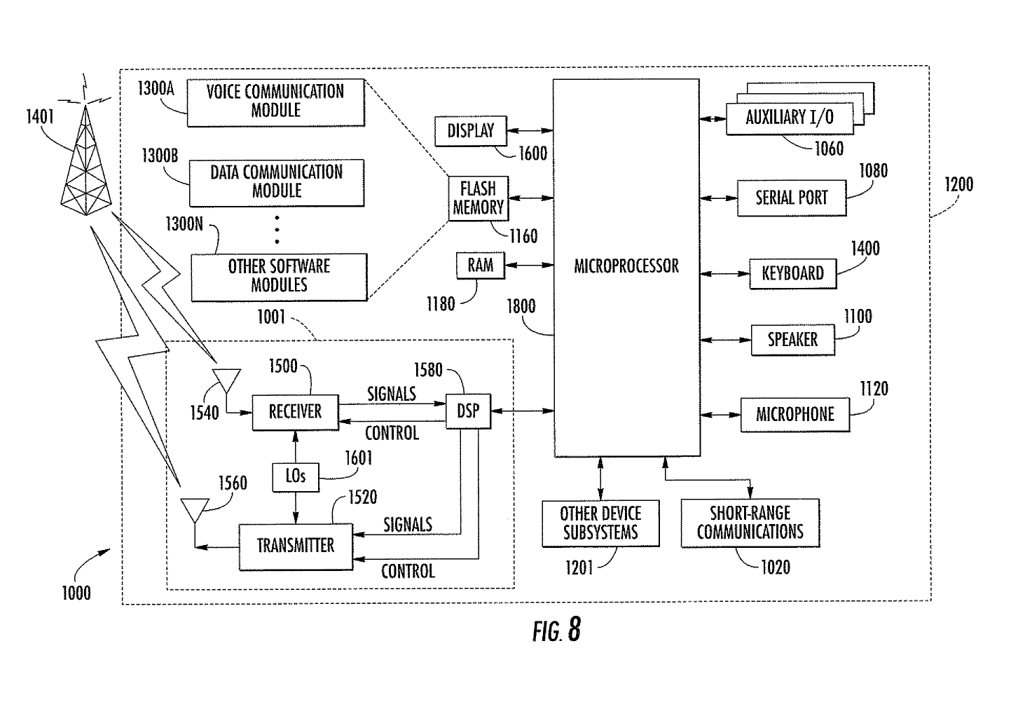

Referring additionally to FIG. 7, a related method for making a wrap-around antenna assembly 34 is now described. Beginning at Block 70, the method includes forming a substrate 35 comprising a first portion and a second portion extending outwardly therefrom defining an L-shape, and positioning a wrap-around antenna element 40 along adjacent contiguous exterior surfaces of the first and second substrate portions, at Blocks 71-72. The method further illustratively includes positioning an antenna feed arm 41 along an interior surface of the first substrate portion and electrically coupled to the wrap-around antenna element 40, at Block 73, and electrically coupling a feed arm extension 42 to the antenna feed arm and extending from the interior surface of the first substrate portion around to the exterior surface thereof, at Block 74, thus concluding the method illustrated in FIG. 7 (Block 75).

Exemplary components of a mobile wireless communications device 1000 that may be used in accordance with the systems 30, 31′, such as for determining traffic rate or density, or both, are further described in the example below with reference to FIG. 8. The device 1000 illustratively includes a housing 1200, a keypad 1400 and an output device 1600. The output device shown is a display 1600, which may comprise a full graphic LCD. In some embodiments, display 1600 may comprise a touch-sensitive input and output device. Other types of output devices may alternatively be utilized. A processing device 1800 is contained within the housing 1200 and is coupled between the keypad 1400 and the display 1600. The processing device 1800 controls the operation of the display 1600, as well as the overall operation of the mobile device 1000, in response to actuation of keys on the keypad 1400 by the user. In some embodiments, keypad 1400 may comprise a physical keypad or a virtual keypad (e.g., using a touch-sensitive interface) or both.

The housing 1200 may be elongated vertically, or may take on other sizes and shapes (including clamshell housing structures). The keypad 1400 may include a mode selection key, or other hardware or software for switching between text entry and telephony entry.

In addition to the processing device 1800, other parts of the mobile device 1000 are shown schematically in FIG. 8. These include a communications subsystem 1001; a short-range communications subsystem 1020; the keypad 1400 and the display 1600, along with other input/output devices 1060, 1080, 1100 and 1120; as well as memory devices 1160, 1180 and various other device subsystems 1201. The mobile device 1000 may comprise a two-way RF communications device having voice and data communications capabilities. In addition, the mobile device 1000 may have the capability to communicate with other computer systems via the Internet.

Operating system software executed by the processing device 1800 may be stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM may be capable of organizing and managing data items, such as e-mail, calendar events, voice mails, appointments, and task items. The PIM application may also be capable of sending and receiving data items via a wireless network 1401. The PIM data items may be seamlessly integrated, synchronized and updated via the wireless network 1401 with the device user's corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TAC™ or General Packet Radio Service (GPRS) mobile data communications networks, and also designed to operate with any of a variety of voice communications networks, such as AMPS, TDMA, CDMA, WCDMA, PCS, GSM, EDGE, etc. Other types of data and voice networks, both separate and integrated, may also be utilized with the mobile device 1000. The mobile device 1000 may also be compliant with other communications standards such as 3GSM, 3G, UMTS, 4G, etc.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore utilizes a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device user may also compose data items, such as e-mail messages, using the keypad 1400 and/or some other auxiliary I/O device 1060, such as a touchpad, a rocker switch, a thumb-wheel, track ball, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, or a Bluetooth™ communications module to provide for communication with similarly-enabled systems and devices.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. A mobile wireless communications device comprising:
a portable housing;
at least one wireless communications circuit carried by said portable housing; and
a wrap-around antenna assembly carried by said portable housing and comprising
a substrate comprising a first portion and a second portion extending outwardly therefrom defining an L-shape,
a wrap-around antenna element lying along adjacent contiguous exterior surfaces of said first and second substrate portions,
an antenna feed arm lying along an interior surface of the first substrate portion and electrically coupled to said wrap-around antenna element, and
a feed arm extension electrically coupled to said antenna feed arm and extending from the interior surface of the first substrate portion around to the exterior surface thereof.

2. The mobile wireless communications device of claim 1 wherein said feed arm extension has a distal end defining a gap from adjacent portions of said wrap-around antenna element.

3. The mobile wireless communications device of claim 2 wherein the gap is not greater than 2 mm.

4. The mobile wireless communications device of claim 1 wherein said feed arm extension has a distal end electrically coupled to adjacent portions of said wrap-around antenna element.

5. The mobile wireless communications device of claim 1 wherein said wrap-around antenna element and said feed arm extension provide pentaband operation.

6. The mobile wireless communications device of claim 1 wherein said wrap-around antenna assembly further comprises a floating, electrically conductive coupler element adjacent said feed arm extension.

7. The mobile wireless communications device of claim 6 wherein said floating, electrically conductive coupler element is spaced apart from and generally parallel to said feed arm extension.

8. The mobile wireless communications device of claim 1 wherein said wrap-around antenna assembly further comprises a monopole antenna element carried by said first portion of said substrate.

9. The mobile wireless communications device of claim 1 further comprising a printed circuit board (PCB) carried by said portable housing and carrying said at least one wireless RF circuit; and wherein said substrate is carried by said PCB.

10. The mobile wireless communications device of claim 1 wherein said wrap-around antenna element comprises an inverted-F antenna element.

11. The mobile wireless communications device of claim 1 wherein said at least one wireless RF circuit comprises at least one cellular transceiver.

12. A wrap-around antenna assembly for mobile wireless communications device comprising a portable housing and at least one wireless communications circuit carried by said portable housing, the wrap-around antenna assembly comprising:
a substrate comprising a first portion and a second portion extending outwardly therefrom defining an L-shape;
a wrap-around antenna element lying along adjacent contiguous exterior surfaces of said first and second substrate portions;
an antenna feed arm lying along an interior surface of the first substrate portion and electrically coupled to said wrap-around antenna element; and
a feed arm extension electrically coupled to said antenna feed arm and extending from the interior surface of the first substrate portion around to the exterior surface thereof.

13. The wrap-around antenna assembly of claim 12 wherein said feed arm extension has a distal end defining a gap from adjacent portions of said wrap-around antenna element.

14. The wrap-around antenna assembly of claim 13 wherein the gap is not greater than 2 mm.

15. The wrap-around antenna assembly of claim 12 wherein said feed arm extension has a distal end electrically coupled to adjacent portions of said wrap-around antenna element.

16. The wrap-around antenna assembly of claim 12 wherein said wrap-around antenna element and said feed arm extension provide pentaband operation.

17. The wrap-around antenna assembly of claim 12 further comprising a floating, electrically conductive coupler element adjacent said feed arm extension.

18. A method for making a wrap-around antenna assembly for a mobile wireless communications device comprising a portable housing and at least one wireless communications circuit carried by the portable housing, the wrap-around antenna assembly comprising:
forming a substrate comprising a first portion and a second portion extending outwardly therefrom defining an L-shape;
positioning a wrap-around antenna element along adjacent contiguous exterior surfaces of the first and second substrate portions;
positioning an antenna feed arm along an interior surface of the first substrate portion and electrically coupled to the wrap-around antenna element; and
electrically coupling a feed arm extension to the antenna feed arm and extending from the interior surface of the first substrate portion around to the exterior surface thereof.

19. The method of claim 18 wherein the feed arm extension has a distal end defining a gap from adjacent portions of the wrap-around antenna element.

20. The method of claim 19 wherein the gap is not greater than 2 mm.

21. The method of claim 18 wherein the feed arm extension has a distal end electrically coupled to adjacent portions of the wrap-around antenna element.

22. The method of claim 18 wherein the wrap-around antenna element and the feed arm extension provide pentaband operation.
